(19) United States
(12) Patent Application Publication
(10) Pub. No.: US 2014/0218360 A1
(43) Pub. Date: Aug. 7, 2014

(54) BIM AND DISPLAY OF 3D MODELS ON CLIENT DEVICES

(71) Applicant: Bent Dalgaard Larsen, Frederiksberg (DK)

(72) Inventor: Bent Dalgaard Larsen, Frederiksberg (DK)

(73) Assignee: DALUX APS, Copenhagen (DK)

(21) Appl. No.: 14/346,531

(22) PCT Filed: Sep. 14, 2012
(86) PCT No.: PCT/DK2012/050343

§ 371 Date: Mar. 21, 2014

Related U.S. Application Data
(60) Provisional application No. 61/537,172, filed on Sep. 21, 2011.

(30) Foreign Application Priority Data
Sep. 21, 2011 (DK) PA 2011 7052

(51) Int. Cl. G06T 17/05

(52) U.S. Cl. CPC G06T 17/05; G06T 2219/20
USPC 345/420

(57) ABSTRACT

The invention relates to the calculation of 2D images from a 3D model, wherein the 2D images may be generated on a computer device and stored on a server for subsequent display on a client device.

The present invention relates to a system and a method for displaying images on a client, such as a client device, wherein the images have been calculated from a 3D model. In particular the invention relates to the calculation of images from a 3D model, wherein the images may be generated on a computer device and stored on a server for subsequent retrieval and display on a client device.

### TECHNICAL BACKGROUND

The patent application EP 1890262 A1 proposes generating a virtual 3D model utilizing photographs of a 3D object from multiple different viewing positions as 2D views, and storing the generated virtual 3D model for display retrieval.

The patent application US 2005/0028111 describes an orientation indicator graphical user interface element in a display view of a three-dimensional scene.

The patent application US 2005/0243083 describes a computer-implemented system allowing a user to access metadata associated with an image being displayed to a user.

The patent application US 2007/180425 describes computer software applications configured to facilitate the interactive design of computer generated models of utility networks.

Cube mapping may be described as a method of environment mapping that uses a six-sided cube as the map shape. The environment is projected onto the six faces of a cube and stored as six square textures, or unfolded into six regions of a single texture. The cube map is generated by first rendering the scene six times from a viewpoint, with the views defined by an orthogonal 90 degree view frustum representing each cube face (Greene, N. 1986. Environment mapping and other applications of world projections. IEEE Comput. Graph. Appl. 6, 11 (November 1986), 21-29).

A quad tree technique has been used for storing image data depicting maps (se also Raphael Finkel and J. L. Bentley (1974). “Quad Trees: A Data Structure for Retrieval on Composite Keys”. Acta Informatica 4 (1): 1-9).

BIM (Building Information Modeling) covers geometry, spatial relationships, light analysis, geographic information, quantities and properties of building components (for example manufacturers' details). BIM can be used to demonstrate the entire building life cycle, including the processes of construction and facility operation. Quantities and shared properties of materials can be extracted easily. Scopes of work can be isolated and defined. Systems, assemblies and sequences can be shown in a relative scale with the entire facility or group of facilities. Dynamic information of the building, such as sensor measurements and control signals from the building systems, can also be incorporated within BIM to support analysis of building operation and maintenance.

### SUMMARY OF THE INVENTION

There is a need for professionals, such as architects and engineers, to present their ideas and models to a wider audience, e.g. to receive feedback from the audience. Large 3D models may use of the order of 1 gigabyte of memory, and require large computational power for rendering images, which may additionally be time consuming. A client device, such as a tablet device, for example using a web browser, may not have sufficient storage space for the 3D model, and even with sufficient memory the rendering of images may be time consuming. Further, the transfer of an entire 3D model by a network may be bandwidth and time consuming and thus costly. There is a need for quick viewing of a 3D model, such as within a second, from the moment a user selects a model until the model is displayed on a client device.

Further, there is a need to reduce the CPU time necessary for complex calculations in order to increase the working speed of computers and mobile devices. There also exists a need to limit the consumption of power on a computer or a mobile device. Related to this, there is a need to limit the heat produced by computers and mobile devices.

According to an aspect of the present invention a system is proposed which improves the perceived performance of a client device by having a server make a number of calculations which is stored for subsequent use. The client device only needs to perform a small number of calculations subsequently, before final presentation of images.

3D models often grow to a size necessitating the use of several separated, part models in order to represent a complete structure, such as a building. For a viewer of the building it is inconvenient to have to change from one part model to another, when examining different parts of the building. There is a need for a system which makes this change from one part of a model to another undetectable by a user viewing the model.

Most contemporary browsers do inherently not carry the capability of showing even small 3D models, and may require the installation of plug-in software. Installation of a plug-in may be time consuming, may require updates, and may imply a security risk. Many companies have IT policies impeding the installation of such plug-in software in browsers. Further, plug-in software may need to be produced in several versions to run on different platforms.

According to another aspect of the invention a system is proposed, wherein a 3D model of e.g. a building can be made available for viewing with a client device, such as a computer or mobile device, having limited CPU and/or GPU power. This may be achieved by calculating a large number of images which are purposefully selected to provide views of the building, such that a user with the client device may have the experience of moving around with respect to the building, without the client device having to perform demanding calculations. Calculations of 3D models may be very demanding, but need in many instances only be performed once, and the results can be stored for later retrieval. In this way expensive as well as power demanding CPU and/or GPU time may be exchanged for inexpensive storage capacity, which additionally may imply less power consumption.

According to an aspect the present invention provides a light application allowing display of a 3D model, such that a user only has read privileges or limited privileges with respect to the 3D model. This may provide security aspects, such as protecting the 3D model from tampering. Further, different users may have different read privileges, thus certain parts of a structure may be made accessible for viewing to only a limited audience. These confidential parts of a structure may comprise security rooms, safe rooms, laboratories, etc. A further security aspect is that copying of the 3D model, e.g. by competitors, is made difficult, as the 3D model is not directly accessible by a user.

According to an aspect the invention provide the user of a client device the opportunity to obtain further information of visible parts of a 3D model. This further information, or metadata, may support BIM.

There is a need to communicate between different users of a 3D model, and between such users and the creators of the 3D model. Hence, according to another aspect, a user of a client device has write privileges concerning at least certain metadata of a 3D model.

According to an aspect, the invention concerns a method for displaying a 3D model on a client device, the method comprising the steps of:
a. Establishing a 3D model on a computer device;
b. Calculating the coordinates of multiple viewpoint positions located relative to said 3D model;
c. Calculating at least one set of images from said 3D model for each of said multiple viewpoint positions, each of said sets comprising at least one image, said at least one image being calculated by environment mapping with respect to the viewpoint position;
d. Storing said multiple sets of images on at least one server;
e. Selecting a viewpoint position of said 3D model on the client device;
f. Allowing the client device to retrieve at least one of said sets of images from the at least one server, said at least one set of images corresponding to said selected viewpoint position;
g. Selecting a viewpoint angle on the client device; and
h. Displaying a part corresponding to said viewpoint angle of said at least one retrieved set of images on the client device.

According to an aspect, the invention concerns a computer system for displaying a 3D model on a client device, said system comprising a computer device, at least one server, and means allowing communication between said at least one server and the client device, said system being configured to: Implement the calculation and storage steps of the method according to the invention.

According to an aspect, the invention concerns an information package for storage on a server and transmission to a client device, said package comprising: a set of images calculated from a 3D model, said set of images having been calculated by environment mapping with respect to a viewpoint position relative to said 3D model; and a set of image formatted data corresponding to said viewpoint position, said image formatted data corresponding to the format of said set of images and comprising metadata pertaining to the visible parts of said 3D model.

According to an aspect, the invention concerns a computer program comprising program code means for performing steps of a method according to the invention, when said program is run on a computer.

According to an aspect, the invention concerns a computer program embodied on a computer readable medium, the computer program controlling a data-processing device to perform steps of a method according to the invention.

### DETAILED DISCLOSURE

Reference is made to a client device, while a person skilled in the art will understand that a virtual client may be used.

While the present invention is not confined to 3D models depicting a building, a building will be used as an example for explanatory purposes.

The present invention is not confined to the use of cube maps, but this term will be used to facilitate the reading.

According to an aspect, the invention concerns a method for displaying a 3D model on a client device, the method comprising the steps of:
a. Establishing a 3D model on a computer device;
b. Calculating the coordinates of multiple viewpoint positions located relative to said 3D model;
c. Calculating at least one set of images from said 3D model for each of said multiple viewpoint positions, each of said sets comprising at least one image, said at least one image being calculated by environment mapping with respect to the viewpoint position;
d. Storing said multiple sets of images on at least one server;
e. Selecting a viewpoint position of said 3D model on the client device;
f. Allowing the client device to retrieve at least one of said sets of images from the at least one server, said at least one set of images corresponding to said selected viewpoint position;
g. Selecting a viewpoint angle on the client device; and
h. Displaying a part corresponding to said viewpoint angle of said at least one retrieved set of images on the client device.

The 3D model may be stored in IFC (Industry Foundation Classes) data format or a similar format, such as, but not limited to, RVT format, DWG format, PLN format and/or DGN format. Various BIM compatible formats may be used.

The coordinates of multiple viewpoint positions may be mutually closely spaced for coordinates close to or within the 3D model. For positions far from the 3D model the coordinates may be spaced farther apart.

According to the invention, environment mapping is performed with respect to the viewpoint position. This may be compared to rotating a fictional camera around the center of projection of the fictional camera, with the center of projection of the fictional camera located at the viewpoint position.

This implies that a user may select a viewpoint position, retrieve a set of images, and following see different parts of the retrieved set of images, corresponding to different viewpoint angles, or corresponding to looking in different directions from the selected viewpoint position.

More than one server may be employed for implementing the process. For example a processor server may be used for calculating set of images from the 3D model, and images may be stored on more than one web server.

The part which is displayed may be the whole set of images, but is usually only a smaller part of said set of images.

According to an embodiment the at least one set of images comprise information allowing the client device to display a stereo view or to provide a stereoscopic 3D effect. This may be achieved by using anaglyph images or color coding, e.g. using a system such as ColorCode 3D, or by using a client device adapted to show different images depending on the viewing angle.

According to an embodiment a user of the client device will use a cross section, such as a plane view, of the 3D model to select a viewpoint position as well as a viewpoint angle.

According to an embodiment a user may first select a viewpoint position from a circle or sphere around a building, facing the building. Alternatively, the user may choose a viewpoint position from a cross section, such as a plane view, through the building.

Preferably, all set of images are calculated in a batch process. Alternatively, set of images may be calculated upon demand from a client device. Even in the alternative, a batch calculation is performed from the outset to provide at least one set of images for multiple viewpoint positions.

According to an embodiment, in addition, images for at least viewpoint position, adjacent to the present position, is retrieved by the client device, allowing quick display of the surroundings of an adjacent position. The adjacent position is preferably a position estimated from at least two former positions, indicating the contemplated movement of a user through the 3D model. Alternatively, according to an embodiment, images for all adjacent positions are retrieved by the client device.

According to an embodiment, the invention concerns a method, wherein said 3D model is a 3D structural model.

According to an embodiment, the invention concerns a method, wherein said 3D model represents an entity selected among the group consisting of an apparatus, a building, a vehicle, and a vessel, such as a submarine or a ship, for example an aircraft carrier.

According to an embodiment, the invention concerns a method, wherein said 3D model represents an entity comprising one or more rooms, and said coordinates of said multiple viewpoint positions comprise at least one coordinate situated within one of said rooms.

A user of the client device may find it particularly relevant to view the inside of a room.

According to an embodiment, the invention concerns a method, wherein said coordinates of said multiple viewpoint positions comprise at least one coordinate situated within each of said rooms.

The viewpoint positions should preferably provide suitable alternatives for a user of the client device, allowing the user to view relevant parts of the 3D model, while keeping the number of viewpoint positions sufficiently restricted to allow a reasonable fast calculation of the corresponding sets of images.

According to an embodiment, the invention concerns a method, wherein the distance between said coordinates of said multiple viewpoint positions is smaller for coordinates within said rooms of said 3D model, and said distance is larger for coordinates outside of said rooms of said 3D model. A user of a client device may prefer to look closely at details within the rooms, while having less need to look closely from the outside of the room, such as outside of an entity comprising the rooms.

According to an embodiment, the invention concerns a method, wherein said 3D model represents an entity comprising one or more walls or barriers, and said coordinates of said multiple viewpoint positions does not comprise any coordinates situated within any of said walls or barriers. The user will usually not have any interest in looking from the inside of a wall, and any potential images generated from a view inside a wall or barrier may make little or no sense to the user.

According to an embodiment, the invention concerns a method, wherein said coordinates of said multiple viewpoint positions are all situated having a minimum distance from said walls or barriers. Many users looking at structural features of e.g. a building will have less interest in looking from viewpoints situated very close to walls, such as less than one meter from a wall. Thus, a suitable minimum distance according to an embodiment is 1 m. Alternative but less preferred minimum distances comprise 0.5 m, 1.5 m, 2 m or 3 m, while other minimum distances may be used depending on the 3D model.

According to an embodiment, the invention concerns a method, wherein said coordinates of said multiple viewpoint positions are all situated having a maximum distance from said walls or barriers. If a user is far away from walls or barriers, the walls or barriers may appear so small to render the view of little use. A suitable maximum distance is 100 m. Alternative but less preferred maximum distances comprise 50 m, 200 m or 500 m, while other maximum distances may be used depending on the 3D model.

According to an embodiment, the invention concerns a method, wherein the distance between said coordinates of said multiple viewpoint positions is smaller for coordinates close to visible parts of said 3D model, and said distance is larger for coordinates farther away from visible parts of said 3D model.

According to an embodiment, the invention concerns a method, wherein at least one distance field is used for generating the coordinates of multiple viewpoint positions. A distance field may be used for allowing the spacing between viewpoint positions to be small close to features of the 3D model, and allow the spacing to be larger, farther away from features of the 3D model.

According to an embodiment, the invention concerns a method, wherein said 3D model comprises at least one floor or ground level, and said multiple viewpoint positions comprise coordinates at a fixed distance above said floor or ground level, said fixed distance representing the height of an observer. As an example, the fixed distance may be 1.70 m, but other fixed distances may be relevant. Other less preferred examples comprise, but are not limited to, 0.5 m, 1.0 m, 1.5 m, and 2.0 m.

According to an embodiment, the invention concerns a method, wherein said 3D model comprises a plurality of floor levels, and said multiple viewpoint positions comprise coordinates at a fixed distance above each of said floor levels, said fixed distance representing the height of an observer.

According to an embodiment, the invention concerns a method, wherein said client device stores one or more images retrieved from said at least one server, allowing subsequent display on said client device. This allows off-line use of the client device for displaying the images.

According to an embodiment, the invention concerns a method, wherein said environment mapping is selected among cube mapping, sphere mapping, paraboloid mapping, pyramid mapping, octahedron mapping, and Healpix mapping.

According to an embodiment, the invention concerns a method, wherein said environment mapping is cube mapping, and each set of images comprise 6 images.

According to an embodiment, the invention concerns a method, wherein said viewpoint angle is in a plane or sphere, preferably a sphere.

According to an embodiment, the invention concerns a method, wherein said set of images is stored in a compressed, preferably lossy compressed, format on said at least one server.

According to an embodiment, the invention concerns a method, further comprising: Calculating a set of data comprising metadata pertaining to the visible parts of said 3D model for each of said multiple viewpoint positions; Storing each of said sets of data in an image format on at least one server, said image format corresponding to the format of said sets of images; Allowing the client device to retrieve at least one of said sets of image formatted data corresponding to said selected viewpoint position; and showing metadata pertaining to a visible part of said 3D model on said client device upon selection by a user.

The image format should correspond to the format of the set of images, e.g. by consisting of the same number of pixels, or by having a fixed ratio of pixels between the image formatted data and the images.

The metadata may correspond to features incorporated by BIM. To provide examples, the metadata may comprise information concerning the performance demands of a heater, spare parts, technical specifications, colors, materials, installation instructions, user manual, maintenance, price, weight, expected lifetime and installation date for a pump, etc.

According to an embodiment, the invention concerns a method, wherein said image formatted data is stored in a loss less format on at least one server.

According to an embodiment, the invention concerns a method, further comprising: Establishing a least one image map, representing a cross section of said 3D model, and displaying said selected viewpoint position relative to said at least one image map on the client device.

According to an embodiment, additionally, the viewing angle may be displayed relative to the image map on the client device.

According to an embodiment, the image maps representing cross sections may be used independently of the images representing 3D views of the 3D model.

According to an embodiment, the image maps may comprise information not appearing from the images of the 3D model. As an example the opening radius of a door or a window may be displayed.

According to an embodiment, the invention concerns a method, further comprising: Calculating a set of data, for each of said at least one image map, comprising metadata pertaining to said at least one image map; Storing each of said sets of data in an image map format on at least one server, said image map format corresponding to the format of said at least one image map; Allowing the client device to retrieve at least one of said sets of image map formatted data; and showing metadata pertaining to at least a part of an image map on said client device upon selection by a user.

According to an embodiment, the invention concerns a method, wherein said image map formatted data is stored in a loss less format on at least one server.

According to an embodiment, the invention concerns a method, wherein the client device is allowed to change, or suggest a change of, at least a part of the metadata, and communicating any of said changes to at least one server.

According to an embodiment, the invention concerns a method, further comprising: Establishing at least one table allowing look up of properties corresponding to said metadata. Preferably an SQL database is used to store the metadata.

According to an embodiment, the invention concerns a method, wherein said client device comprises at least one GPU, and wherein said method further comprises: Generation of a texture stored in an image format, said texture comprising information indicating different possible colors for different types of features of said visible parts of said 3D model; and Selecting one of the possible colors for a specific type of features on said client device, allowing the GPU of said client device to change the color of a specific type of features.

The information in the generated texture corresponds to a table comprising different possible colors for specific features, the table being calculated from a number of rules dictated by the model. As an example, the generation of a texture stored in an image format may be conducted on a computer device or server, having access to the 3D model, and the generated texture may be send to the client device. Subsequently, a user of a client device may be provided the opportunity to change the color of specific features, e.g. all pipes carrying hot water may be changed to the color red, or all pipes may be changed to the color grey. The GPU of a client device is specifically adapted to make computations of data stored in an image format quickly. Thus, by storing the information in a texture in an image format, the computation can be made quickly on the client device, without the need to retrieve an image.

According to an embodiment, the invention concerns a method, further comprising: Calculating at least one additional set of images from said 3D model for at least one viewpoint position, said additional set of images comprising at least one image, said at least one additional set of images being calculated by environment mapping with respect to the viewpoint position in the absence of at least one otherwise visible object of said 3D model; wherein metadata pertaining to said 3D model identifies which objects belong together.

The more than one set of images allow presentation of details which are not readily visible for a selected viewpoint, but hidden behind other, visible objects. Metadata pertaining to the 3D model may be used to identify which visible objects belong to the same part or object.

According to an embodiment, the invention concerns a method, further comprising: Allowing the client device to retrieve at least one of said additional set of images from the at least one server, said at least one additional set of images corresponding to said selected viewpoint position; Selecting at least one visible object, which hides structural details behind it, on the client device; Allowing the client device to use metadata to identify the borders of said at least one object on said at least one retrieved set of images; and allowing the client device to replace the part of said at least one retrieved set of images with the corresponding part of said at least one retrieved additional set of images.

This embodiment allows the client device to calculate a new image, by simple manipulation of images without the need of a complex 3D calculation necessitating a large model. Naturally, these steps may be performed several times to show additional details hidden behind other objects.

According to an embodiment, typically, an edit mode may be selected on the client device, upon which the client device retrieves the relevant additional set of images.

According to an embodiment, the invention concerns a method, further comprising: Calculating coordinates of corners or borders of objects from said 3D model; Storing said coordinates on at least one server; Selecting at least two displayed objects on the client device; Allowing the client device to retrieve coordinates for calculation of the distance between said at least two selected objects; Calculating said distance; and displaying said calculated distance on the client device.

Calculating distances directly from coordinates derived from vectors of the 3D model allow the exact distances between objects to be calculated. If the distances are calculated from pixels of an image, inaccuracies or errors may occur.

According to an embodiment, the invention concerns a method, said method further comprising: Calculation of additional coordinates of additional viewpoint positions; Calculation of at least one set of images from said 3D model for each of said additional viewpoint positions; and Storing said set of images for said additional viewpoint positions on at least one server for retrieval on said client device.

This allows a user to obtain additional views of the 3D model. As an example, a first calculation may provide images for 100 different viewpoint positions, which may be viewed right after the first calculation, while a subsequent calculation may provide images for 400 additional viewpoint positions, which may also be viewed after the subsequent calculation is completed.

According to an embodiment, the invention concerns a method, wherein the client device comprises means for locating the position of the client device, such as a GPS, allowing the viewpoint position to be selected according to the position of the client device.

According to an embodiment, the invention concerns a method, wherein the client device comprises means for locating the direction of the client device, such as a compass or gyroscope, allowing the viewpoint angle to be selected according to the direction of the client device.

According to an embodiment, the invention concerns a method, wherein the client device uses an Internet browser for display. The client device may be a tablet using a web browser for display.

According to an embodiment, the invention concerns a method, wherein the client device is portable.

According to an embodiment, the invention concerns a method, wherein the client device is a smart phone.

According to an embodiment, the invention concerns a computer system for displaying a 3D model on a client device, said system comprising a computer device, at least one server, and means allowing communication between said at least one server and the client device, said system being configured to: Implement the calculation and storage steps of a method according to the invention.

According to an embodiment, the invention concerns an information package for storage on a server and transmission to a client device, said package comprising: a set of images calculated from a 3D model, said set of images having been calculated by environment mapping with respect to a viewpoint position relative to said 3D model; and a set of image formatted data corresponding to said viewpoint position, said image formatted data corresponding to the format of said set of images and comprising metadata pertaining to the visible parts of said 3D model.

According to an embodiment, the invention concerns an information package, wherein said image formatted data is in a loss less format.

According to an embodiment, the invention concerns an information package, wherein said images are in a lossy compressed format.

According to an embodiment, the invention concerns an information package, wherein said image formatted data allow lookup in a table for interpretation of the contents of the data in said set of image formatted data.

According to an embodiment, the invention concerns a computer program comprising program code means for performing the computer device steps of a method according to the invention, preferably steps a., b., and c. of claim 1, when said program is run on a computer.

According to an embodiment, the invention concerns a computer program comprising program code means for performing the server steps of a method according to the invention, preferably step d. of claim 1, when said program is run on a computer.

According to an embodiment, the invention concerns a computer program comprising program code means for performing the client device steps of a method according to the invention, preferably steps e., f., g., and h. of claim 1, when said program is run on a computer.

According to an embodiment, the invention concerns a computer program embodied on a computer readable medium, the computer program controlling a data-processing device to perform the computer device steps of a method according to the invention, preferably steps a., b., and c. of claim 1.

According to an embodiment, the invention concerns a computer program embodied on a computer readable medium, the computer program controlling a data-processing device to perform the server steps of a method according to the invention, preferably step d. of claim 1.

According to an embodiment, the invention concerns a computer program embodied on a computer readable medium, the computer program controlling a data-processing device to perform the client device steps of a method according to the invention, preferably steps e., f., g., and h. of claim 1.

### FIGURES

FIG. 1 shows a schematic representation of an embodiment of the present invention. The figure outlines steps for implementing an embodiment of the invention.

FIG. 2 shows a schematic representation of an embodiment of the present invention. The figure illustrates how data may be transferred from a computer device, a PC, via a server, to several client devices.

FIG. 3 shows a schematic representation of an embodiment of the present invention.

FIG. 4-10 are various examples of presentation views on a client device.

FIG. 4 is an example of a presentation of a structural model of a building on a client device. The user may select the coordinates of a viewpoint from a circle around the structural model of the building.

FIG. 5 is an example of a presentation of the structural model of the building on a client device. The user may select an image map, and subsequently the coordinates of a viewpoint on the image map.

FIG. 6 is an example of a presentation of a structural model of a building on a client device. The user has selected a first image map, representing the first floor of the building. The user may select the coordinates of a viewpoint on the image map.

FIG. 7 is an example of a presentation of the structural model of the building on a client device. The user has selected a second image map, representing the second floor of the building. The user may select the coordinates of a viewpoint on the image map.

FIG. 8 is an example of a presentation of the structural model of the building on a client device. The user has selected the second image map, representing the second floor of the building. The user may select the coordinates of a viewpoint on the image map, e.g. by moving a figure around on the image map.

FIG. 9 is an example of a presentation of a part of a structural model of a building on a client device. The left part shows a part of a set of retrieved images on a client device corresponding to a selected viewpoint position and a selected viewpoint angle. In the lower right part is displayed an image map allowing the selection of another viewpoint position. In the upper right part accessible image maps are listed, allowing the user to select which image map is being displayed.

FIG. 10 is an example of a presentation of the same part on a client device. Here, the user may select a displayed object and obtain metadata concerning the object. In this case the user has chosen an object. The metadata shows that it is a column (“søjle”) with the number B5. The metadata further shows that the object has a volume of 2 m³, and a surface of 3 m².

FIG. 11a-c ID are six image representations of depicted images and meta data.

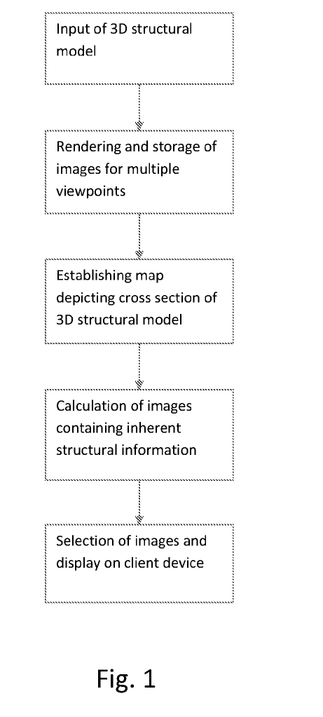

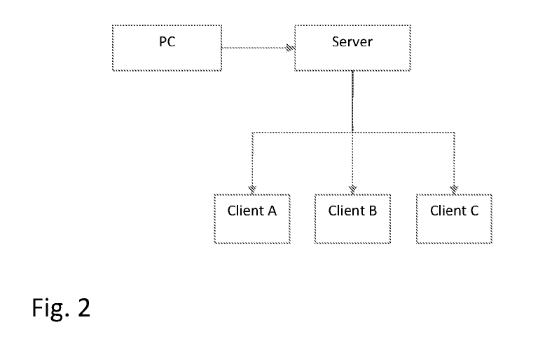

All cited references are incorporated by reference.

The accompanying Figures and Examples are provided to explain rather than limit the present invention. It will be clear to the person skilled in the art that aspects, embodiments and claims of the present invention may be combined.

### Example 1

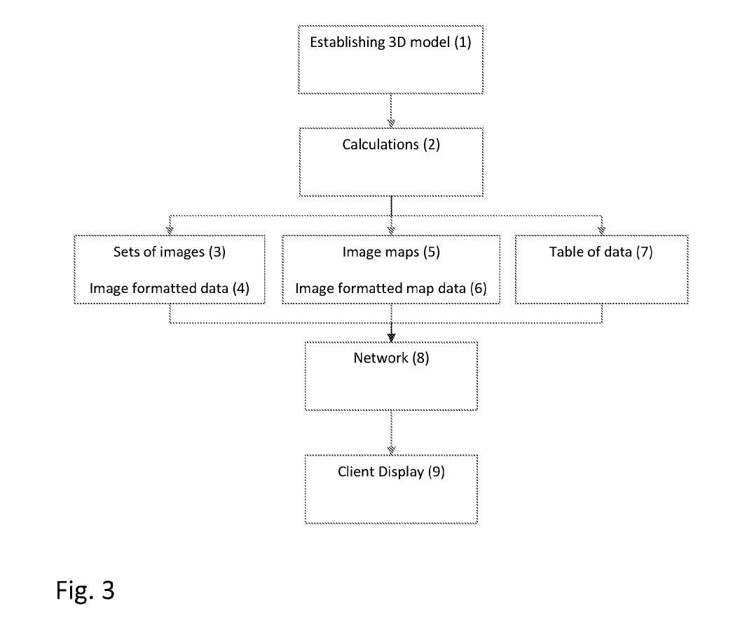

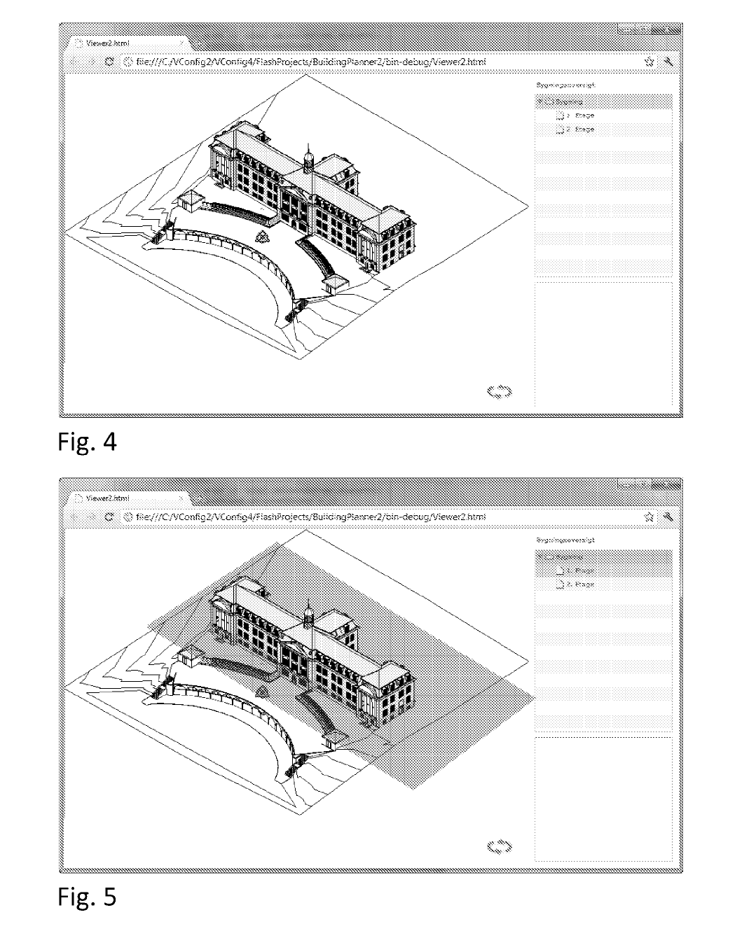

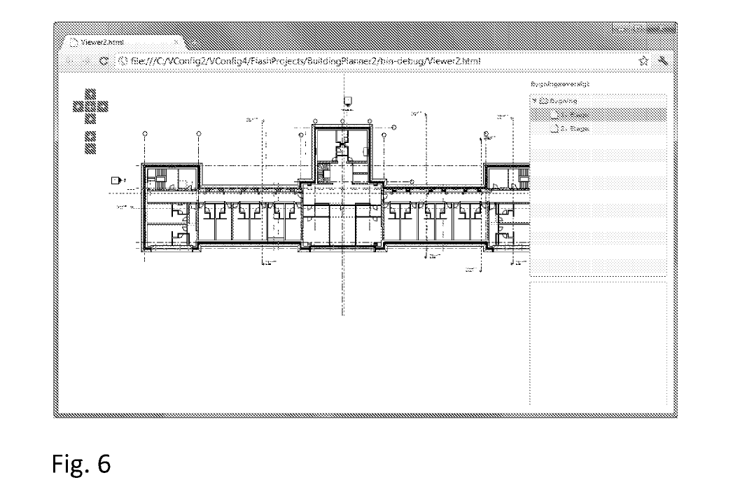

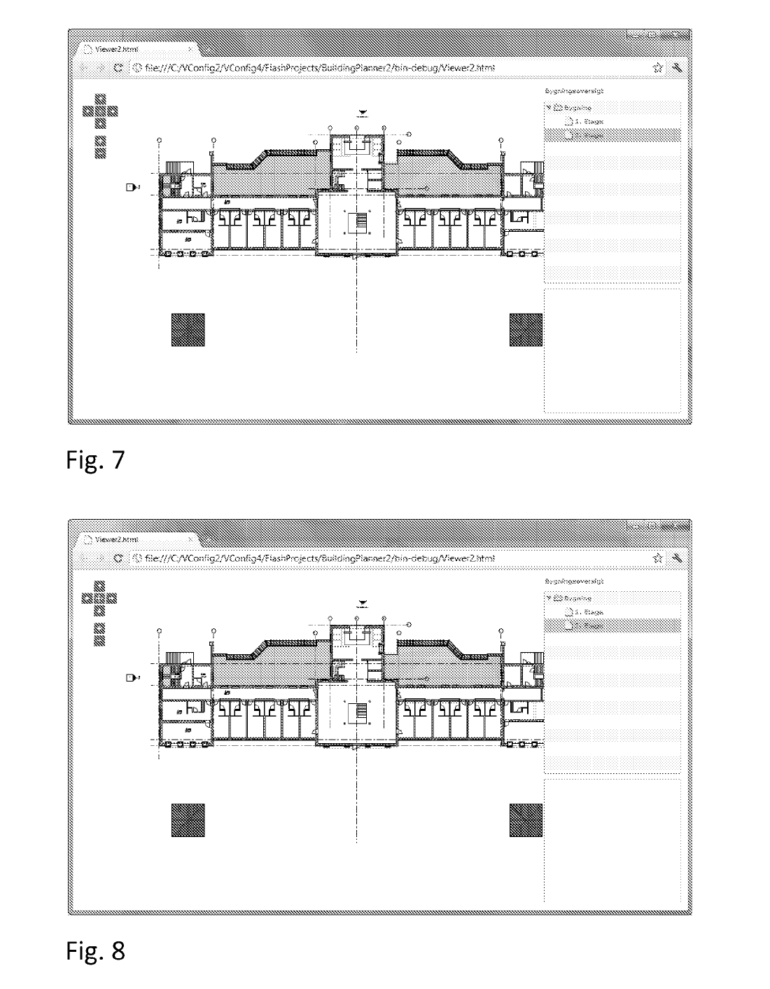

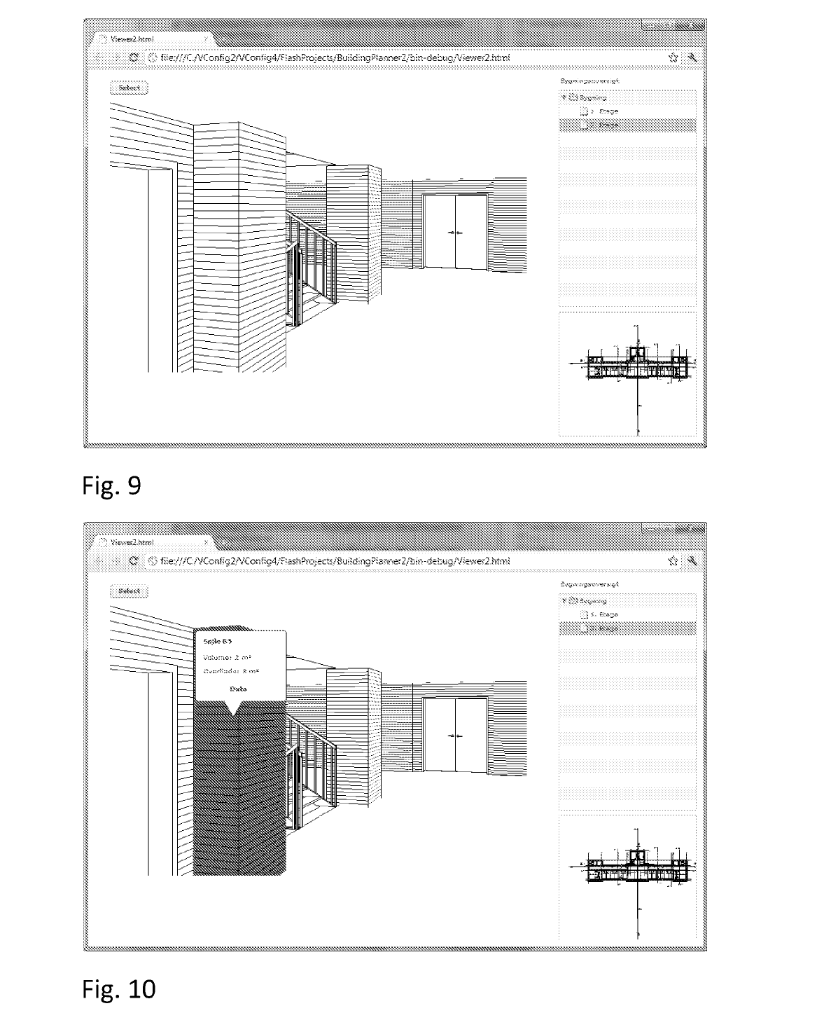

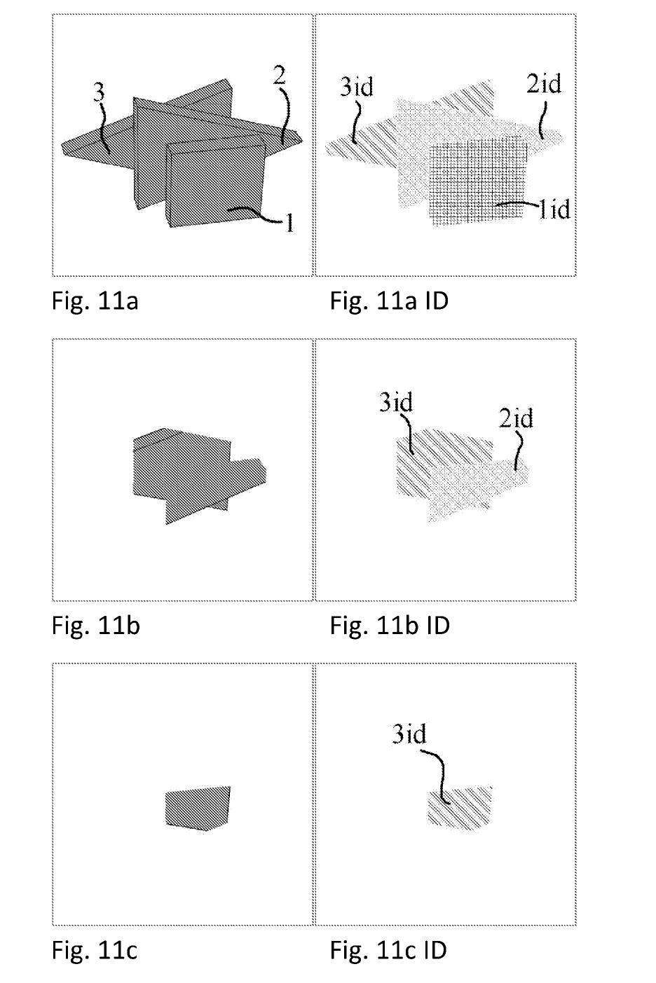

The following is an example which describes an embodiment of the present invention. Reference is made to FIG. 3.

### (1) Establishing Model

The model is a digital model of a building loaded from the IFC format. The digital model contains a 3D model, at several cross-sections and metadata on the objects.

### (2) Calculations

The processor takes the building model as input and creates part (3), (4) and (5).

### (3) Sets of Images

The sets of images are cubemaps generated on a number of positions. A large number of positions are generated close to the building, while a few positions are generated some distance from the building. A simple algorithm is generating a 3D grid with 1 meter spacing on a bounding box of the building. Further, multiple positions are generated with a fixed distance to cross-sections making it easy to select a 3D position from a cross section view. A cubemap is generated depicting the 3D surroundings at each position. The images are stored in the jpg format.

### (4) Image Formatted Data

Image formatted data, representing metadata, are generated for each set of images. Preferably in the same resolution, but images with a smaller size can also be used. In the image formatted data the colors are used as an identifier representing the object that is displayed at that position. The images are compressed using a the lossless format png.

### (5) Image Maps

The cross sections are stored as vectors, arcs etc. in the IFC file. A quad tree with images is generated for each of the cross sections. The images are compressed using the lossless png. This makes it possible for a user to zoom in the quad tree representation of the cross sections while the vector lines remains equally thin on the screen.

### (6) Image Formatted Map Data

Image formatted data are generated for each of the images in the 2D quad tree. In the image formatted data the colors are used as an identifier representing the object that is displayed at that position. The images are preferably compressed using the lossless format png.

### (7) Table of Data

The data are properties of the objects in the building, i.e. metadata. For each identifier in the model (as rendered in both the quad tree images representing the cross sections and the cubemap images of the 3D model) there may be a number of properties associated with the objects of the building. The properties describe the characteristics of the object in the building (e.g. window parameters, wall parameters etc., such as dimensions and/or materials).

### (8) Network

The data is accessed over the network. The image files of both the quad tree and the cubemaps are accessed from directories on a web server. The metadata (7) is stored in a regular SQL database and accessed using a web service.

### (9) Client Display

The client device may use a web browser (with or without a plug-in like Flash, Silverlight etc.). Alternatively, the client device may be a mobile phone/smart phone/tablet.

The client preferably has a lightweight program that makes it easy to browse the image maps and the 3D views.

### Example 2

The following is an example which describes an embodiment of the present invention, wherein the client device replaces a visible object with objects hidden behind the visible object. Reference is made to FIG. 11a-c ID, which are six image representations of depicted images and metadata. For explanatory purposes two-dimensional images are used here, while complete cubemaps may be used in an actual implementation.

The six images of FIG. 11a-FIG. 11c ID have the same number of pixel, and the same dimensions, i.e. the same width and the same height. FIG. 11a shows an image with the objects denoted (1), (2) and (3). FIG. 11a ID is image formatted data comprising the corresponding metadata.

As an example, the image of FIG. 11a is displayed on a client device. When a user selects an object visible on FIG. 11a, e.g. object (2), the client device will use the metadata of FIG. 11a ID to identify which parts of the displayed image belongs to the object, i.e. the part denoted (2id). The client device subsequently removes the selected object from the display and replaces these parts of the image with the parts of FIG. 11b having the same pixel coordinates. Hence, what is now displayed is an image made up of parts from FIG. 11a and FIG. 11b. Similarly, the client device calculates a new set of image formatted data using metadata from FIG. 11a ID, wherein the metadata of (2id) is replaced with the metadata of FIG. 11b ID having the same pixel coordinates. This new set of image formatted data will thus not comprise metadata belonging to object (2).

If the user subsequent selects another object visible on the client device, e.g. object (1), the client device will use the metadata of the new set of image formatted data to identify which parts of the displayed image belongs to the object, i.e. the part denoted (1id). The client device subsequently removes the selected object from the display and replaces these parts of the image with the parts of FIG. 11b having the same pixel coordinates. However, as object (2) is not displayed, for the pixels wherein the metadata of FIG. 11b ID indicates object (2) is present, the pixels are replaced with pixels of FIG. 11c for display.

In this way one object after the other may be removed for displaying parts hidden behind them, by simple calculations on the client device.

1. A method for displaying a 3D model on a client device, the method comprising the steps of:
a. Establishing a 3D model on a computer device;
b. Calculating the coordinates of multiple viewpoint positions located relative to said 3D model;
c. Calculating at least one set of images from said 3D model for each of said multiple viewpoint positions, each of said sets comprising at least one image, said at least one image being calculated by environment mapping with respect to the viewpoint position;
d. Storing said multiple sets of images on at least one server;
e. Selecting a viewpoint position of said 3D model on the client device;
f. Allowing the client device to retrieve at least one of said sets of images from the at least one server, said at least one set of images corresponding to said selected viewpoint position;
g. Selecting a viewpoint angle on the client device; and
h. Displaying a part corresponding to said viewpoint angle of said at least one retrieved set of images on the client device.

2. The method according to claim 1, wherein said 3D model is a 3D structural model.

3. (canceled)

4. The method according to claim 1, wherein said 3D model represents an entity comprising one or more rooms, and said coordinates of said multiple viewpoint positions comprise at least one coordinate situated within one of said rooms.

5. (canceled)

6. The method according to claim 1, wherein the distance between said coordinates of said multiple viewpoint positions is smaller for coordinates within said rooms of said 3D model, and said distance is larger for coordinates outside of said rooms of said 3D model.

7. The method according to claim 1, wherein said 3D model represents an entity comprising one or more walls or barriers, and said coordinates of said multiple viewpoint positions does not comprise any coordinates situated within any of said walls or barriers.

8. The method according to claim 7, wherein said coordinates of said multiple viewpoint positions are all situated having a minimum distance from said walls or barriers.

9. (canceled)

10. The method according to claim 1, wherein the distance between said coordinates of said multiple viewpoint positions is smaller for coordinates close to visible parts of said 3D model, and said distance is larger for coordinates farther away from visible parts of said 3D model.

11. The method according to claim 1, wherein at least one distance field is used for generating the coordinates of multiple viewpoint positions.

12. The method according to claim 1, wherein said 3D model comprises at least one floor or ground level, and said multiple viewpoint positions comprise coordinates at a fixed distance above said floor or ground level, said fixed distance representing the height of an observer.

13. (canceled)

14. (canceled)

15. (canceled)

16. (canceled)

17. (canceled)

18. (canceled)

19. The method according to claim 1, further comprising:
Calculating a set of data comprising metadata pertaining to the visible parts of said 3D model for each of said multiple viewpoint positions;
Storing each of said sets of data in an image format on at least one server, said image format corresponding to the format of said sets of images;
Allowing the client device to retrieve at least one of said sets of image formatted data corresponding to said selected viewpoint position; and
Showing metadata pertaining to a visible part of said 3D model on said client device upon selection by a user.

20. (canceled)

21. The method according to claim 1, further comprising:
Establishing a least one image map, representing a cross section of said 3D model, and
Displaying said selected viewpoint position relative to said at least one image map on the client device.

22. The method according to claim 21, further comprising:
Calculating a set of data, for each of said at least one image map, comprising metadata pertaining to said at least one image map;
Storing each of said sets of data in an image map format on at least one server, said image map format corresponding to the format of said at least one image map;
Allowing the client device to retrieve at least one of said sets of image map formatted data; and
Showing metadata pertaining to at least a part of an image map on said client device upon selection by a user.

23. (canceled)

24. The method according to claim 19, wherein the client device is allowed to change, or suggest at change to, at least a part of the metadata, and communicating any of said changes to at least one server.

25. (canceled)

26. (canceled)

27. The method according to claim 1, further comprising:
Calculating at least one additional set of images from said 3D model for at least one viewpoint position, said additional set of images comprising at least one image, said at least one additional set of images being calculated by environment mapping with respect to the viewpoint position in the absence of at least one otherwise visible objects of said 3D model; wherein metadata pertaining to said 3D model identifies which objects belong together.

28. The method according to claim 27, further comprising:
Allowing the client device to retrieve at least one of said additional set of images from the at least one server, said at least one additional set of images corresponding to said selected viewpoint position;
Selecting at least one visible object which hides structural details behind it, on the client device;
Allowing the client device to use metadata to identify the borders of said at least one object on said at least one retrieved set of images;
Allowing the client device to replace the part of said at least one retrieved set of images with the corresponding part of said at least one retrieved additional set of images.

29. The method according to claim 1, further comprising:
Calculating coordinates of corners or borders of objects from said 3D model;
Storing said coordinates on at least one server;
Selecting at least two displayed objects on the client device;
Allowing the client device to retrieve coordinates for calculation of the distance between said at least two selected objects;
Calculating said distance; and
Displaying said calculated distance on the client device.

30. (canceled)

31. The method according to claim 1, where the client device comprises means for locating the position of the client device, allowing the viewpoint position to be selected according to the position of the client device.

32. The method according to claim 1, where the client device comprises means for locating the direction of the client device, allowing the viewpoint angle to be selected according to the direction of the client device.

33. (canceled)

34. (canceled)

35. (canceled)

36. A computer system for displaying a 3D model on a client device, said system comprising a computer device, at least one server, and means allowing communication between said at least one server and the client device, said system being configured to: Implement the calculation and storage steps of the method according to claim 1.

37. (canceled)

38. (canceled)

39. (canceled)

40. (canceled)

41. A computer program comprising program code means for performing the computer device steps of claim 1, when said program is run on a computer.

42. (canceled)

43. A computer program comprising program code means for performing the client device steps of claim 1, when said program is run on a computer.

44. (canceled)

45. (canceled)

46. (canceled)
